(19) United States
(12) Patent Application Publication
(10) Pub. No.: US 2009/0319561 A1
(43) Pub. Date: Dec. 24, 2009

(54) Arrangement and a Method for Delivering a Lost Object to a User, And An Arrangement and a Method of Providing a Finder of An Identification Item With User Data

(76) Inventors: Daphne Roswita Hosp, Durham, NC (US); Ruediger Hosp, Breisach (DE)

Correspondence Address: SMITH FROHWEIN TEMPEL GREENLEE BLAHA, LLC, Two Ravinia Drive, Suite 700, ATLANTA, GA, 30346, US

(21) Appl. No.: 12/090,627

(22) PCT Filed: Oct. 20, 2006
(86) PCT No.: PCT/IB06/02960

§ 371 Date: Sep. 15, 2008

Related U.S. Application Data
(60) Provisional application No. 60/729,317, filed on Oct. 21, 2005.
(60) Provisional application No. 60/734,236, filed on Nov. 7, 2005.

(30) Foreign Application Priority Data
Oct. 21, 2005 (EP) 05023113

(51) Int. Cl. G06F 17/30; G06K 7/00; G06Q 99/00

(52) U.S. Cl. 707/103 R; 340/10.1; 705/1; 707/E17.055

(57) ABSTRACT

An arrangement and a method for delivering a lost object to a user, and an arrangement and a method of providing a finder of an identification item with user data. An arrangement, comprising a control unit, a database, and an identification item, wherein the identification item comprises unique identification information and is adapted to be connected to an object, wherein the database is accessible to a user to provide user data for registering the object in connection with the identification item, wherein the control unit is accessible to a finder of the object connected to the identification item to inform the control unit, based on the unique identification information, that the finder has found the object connected to the identification item, wherein the control unit is adapted to instruct a delivery service unit to deliver the object connected to the identification item to the user based on the user data in case the finder has noticed that the finder has found the object.

This application claims the benefit of the filing date of European Patent Application No. 05023113 filed Oct. 21, 2005, of U.S. Provisional Patent Application No. 60/729,317 filed Oct. 21, 2005, and of U.S. Provisional Patent Application No. 60/734,236 filed Nov. 7, 2005, the disclosure of which is hereby incorporated herein by reference.

The invention relates to the field of identification items. Particularly, the invention relates to an arrangement and to a method for delivering a lost object to a user, and to an arrangement and to a method of providing a finder of an identification item with user data.

It may happen that a person loses an object, for instance a key or a notebook. In this case, such a loss may cause severe inconveniences and costs.

It may also be that a person is in an accident and needs immediate medical attention. In such a situation lack of medical information related to the person may cause a perilous situation for the person.

There may be a need for a reliable finder system.

This may be achieved by providing an arrangement and a method of delivering a lost object to a user and by providing an arrangement and a method of providing a finder of an identification item with user data with the features according to the independent claims.

According to an exemplary embodiment of the invention, an arrangement is provided comprising a control unit, a database, and an identification item, wherein the identification item comprises unique identification information and is adapted to be connected to an object, wherein the database is accessible to a user (for instance exclusively) to provide user data for registering the object in connection with the identification item, wherein the control unit is accessible to a finder of the object connected to the identification item to inform the control unit, based on the unique identification information, the finder has found the object connected to the identification item, wherein the control unit is adapted to instruct a delivery service unit to deliver the object connected to the identification item to the user based on the user data in case that the finder has noticed that the finder has found the object.

According to another exemplary embodiment of the invention, a method of delivering a lost object to a user is provided, the method comprising connecting an identification item comprising unique identification information to the object, providing, by the user, user data for registering the connection of the object to the identification item, noticing, by a finder of the object connected to the identification item, that the finder has found the object connected to the identification item, providing, by the finder, the unique identification information, picking up the object from the finder and delivering the object to the user-based on the user data.

According to a further exemplary embodiment of the invention, an arrangement is provided comprising a control unit, a database and an identification item, wherein the identification item comprises unique identification information and is adapted to be assigned to a user. The database is accessible to the user to provide user data for registering the user in connection with the identification item. The control unit is accessible to a finder of the identification item assigned to the user to inform the control unit, based on the unique identification information, that the finder has found the identification item assigned to the user. The control unit is adapted to provide the finder with the user data in case the finder has noticed that the finder has found the identification item.

According to yet another exemplary embodiment of the invention, a method of providing a finder of an identification item with user data is provided. The method comprises assigning unique identification information of the identification item to a user, providing, by the user, the data for registering the user in connection with the identification item, a finder noticing the identification item and that the finder has found the identification item, the finder providing the unique identification information, and providing the finder with the user data when the finder has noticed that the finder has found the identification item.

According to an exemplary embodiment of the invention, an easy, reliable and worldwide usable system for finding and transporting back a lost item to the assigned owner may be provided. The system may rely upon the following procedure: A user connects, for instance mechanically, an object (for instance a key) with an identification item (for instance a metal plate) on which unique identification information may be provided (for instance an alphanumeric code engraved in the metal plate). The user registers this connection procedure in a database so that this central database of the finding system includes a link between the unique identification information, the user and the object. In case that a user later loses the item connected to the identification item, a finder may use information provided by the identification item (for instance a telephone number of a call center, a URL, or the like) to contact the control unit of the arrangement so as to give notice that the finder has found the object with the connected identification item. The control unit may then derive the user identity or other user-related contact information by querying the database in which the correlation between the user and the object is stored. When the system has identified the owner of the lost object, the delivery service (for instance a shipping company) may be instructed to visit the finder, pick up the object and bring the object back to the user. The delivery service can thus be activated by the central control unit.

A significant advantage, as will be described below in more detail, is that the usage of the system may allow a user to remain anonymous. Furthermore, user data may be accumulated in large amounts and may be reused for marketing or other purposes. Particular portions of such data may be made selectively accessible for special addressees, for instance a particular company. Such a company may use the data then, for example, to specifically contact the user(s) related to the respective data. For instance, the company may then send emails with questions/offers to such user(s).

Thus, according to an exemplary embodiment, a system is provided in which a user registers himself in a database, and when an item registered in the database is lost and then found by a finder, the finder may inform the finding system about this event. A shipping company may be automatically instructed to transport the property back to the owner. For this purpose, the identification item may be physically attached to the object to be protected.

Another aspect of the invention becomes apparent in the feature that the user data stored in the database during registration may be used as well for statistical, analytical or marketing purposes, for instance to derive information regarding the economic consumer behaviour or preferences of different users. A sticker (for instance with a hologram) may be connected with an object like a laptop, a telephone, an MP3 player, a PPS portable play station, a DPS digital play station, a digital-/video recorder, a digi-cam, a digital camera or any other camera with corresponding objective, a laptop and printer, a mobile phone, a portable music device, a portable video device, a PDA or any other device. Such a sticker may be made of a material having self-destroying properties in case a user or finder tries to remove the sticker from the object to be protected. By taking this measure, imitations or misuse may be prevented.

Data of a variety of identification items connected to objects all over the world may be stored in a single central database (for instance a relational database) which may be easily accessed and queried in order to find contact information needed to inform a user that she or he has lost the object and that the object will be transported back from the finder's location to the user's location by means of the transportation entity. Such transportation may be performed only if required or desired by the user and may be free of charge (e.g. in the case of a key) or may be a paid service (e.g. in the case of larger elements like a laptop).

The object may be a person. Thus, the arrangement may be used by a dating agency, a marriage bureau or a matchmaking company. Furthermore, children can be found in the chaos of a soccer stadium, or it is possible to find persons in war regions.

It is also possible to use the finding mechanism as a messenger. It is possible to instruct a third party to send a message or an object. The third party does not know the address of the addressee and, in some cases, is not supposed to know the address. The third party then provides the unique identification information of the addressee. Then, the user may access the finding mechanism (for instance via accessing an Internet homepage) and may initiate a pickup procedure of the message or the object. In other words, the delivery service will collect a message or a package and may transport this to the addressee.

According to an exemplary embodiment, a key finding system is provided which enables a lost/found key to be returned irrespective of the circumstances surrounding where and how the key has been lost/found (preferably without charging) to the owner. This finding system can be extended to any desired object. The delivery service may be adapted to the size of the object. Such a system is anonymous, simple in construction, cheap in maintenance and may make it possible to register almost any object at any time with a security and registration system, using a database which may be accessible by anyone for registration and reporting a found item. The configuration of the database may be such that no unauthorized person is able to assign a registered identification number to an owner. By taking this measure, misuse may be prevented. Moreover, the configuration of the database may be such that no unauthorized person may have full and unrestricted access to all (user) data stored in the database.

It is possible that only authorized persons may have access to (the entire or selectively to a part of) the database. The database may be password-protected.

One exemplary aspect of the invention is a key pendant, sticker or iron-on tag which carries an individual indicia, for instance a number. By means of such an identification number, the user may register with his or her personal data in a database. On the pendant or the like, the URL of a homepage of the finder system and/or the telephone number of a hotline of the finder system may be provided. The identification item may include as well a promise to provide a reward in case the finder has found the object and takes necessary steps to initiate the transport of the object back to the owner.

The computer database may be part of the finder service. Only the finder service may be authorized to use this database in order to assign the object to the owner in case of a loss of the object. This assignment may only take place in case the object is found.

Promising the finder a reward for initiating the return of the object to the owner (this reward may be providing at least one identification item as a gift) may motivate the finder to give notice that she or he has found the key or other object. Thus, taking this measure may improve the efficiency of the system.

If a finder has found an object, he or she may notify the finder system by logging into a homepage of the finder system (for instance www.swissfinder.com). Additionally or alternatively, the finder may call up a headquarter of the finder system (for instance under a telephone number). Additionally or alternatively, the finder may throw the found object in a mailbox.

Logging into the homepage of the finder system may automatically initiate an international courier service which then collects the key or other object at the finder's location and brings back this object to the owner. Optionally, the owner of the object may be informed that the object has been found.

When the finder gives a call to the headquarters of the finder system, this call may be directly conveyed to the international courier service. The courier service may collect the key at the finder's location and may bring it back to the owner. The finder's call may also be directed to a call center which then initiates the transport of the key to the owner.

According to an exemplary embodiment, including using the user information for marketing purposes, a client binding and marketing instrument based on an Internet database for a finder system using an identification system may be provided. The user provides personal data to the database when registering an object and an assigned unique identification code. In order to generate consumer data (which may be sold to companies), a marketing and client binding instrument is installed. The user data provided by the user during registration can be collected and can be used, by the company or by other companies, for purposes such as market research, client behaviour, client binding, client acquisition, product development, product re-launch or product initiation.

With a system according to an exemplary embodiment, it is possible to leave a registrable identification number of a user or object. A worldwide finder back transport service or information service (the latter may provide information with respect to the object like the present location of the object, the finder of the object, or the like) may then send back the object to the user. Simultaneously, the operator of the arrangement for delivering a lost object to a user may continuously be provided with current/up-dated client/consumer data.

In order to ensure that the consumer identifies himself/herself with a key finder, it is possible to print a logo or trademark of a well-known company on the identification item, which supports the finder system. For instance, with each mobile phone sold by a well-known mobile phone company, the mobile phone company may provide the buyer with an identification item as a gift. The finder service system described herein may be provided without charging the buyer additionally. The company's logo may also be provided on the identification item. This may improve the acceptance of the finder system.

The finder system may also be implemented in the context of insurance. When a consumer buys insurance at an insurance company, for protecting an object, the insurance company may make an agreement with the client requiring the client to physically connect the object (being the insured subject) to the identification item. Only after the registration, the insurance protection will become effective.

Thus, the described finder system is an efficient marketing instrument for improving client relations particularly of premium trademark product manufacturers and service providers. It works as a Trojan marketing tool for generating client data of enormous qualities and quantities within a short time interval. This may be obtained by providing an object finder free of charge, optionally with a premium trademark label (commercial label) on it. Each object finder may be assigned by its unique identification number and corresponding print-on of a label (company logo).

A (key) pendant as an example of an identification item and may comprise the following components:

An oval plate which may be made of metal and which may have a size of 2×30×60 mm³ and a hole of the size of, for instance, 5 mm. The pendant may be connected to a key ring or another object through the hole. The following inscription may be provided on the front and back side:

Front plate:

Inscription with the label (for instance “swissfinder”, “key finder”, “bag finder”, “rescue finder”, “senior finder”, “kid finder”, “fon finder”, “pet finder”, “army finder”, “gear finder”, “dive finder”, etc.)

Inscription “Identification No.” or “Ident. No.” and “Auxiliary number” or “Verification number”.

An “Auxiliary number” may improve confidentiality of the system and may make it even more difficult for a hacker to log into the system.

An alphanumeric combination with, for instance, nine or ten digits for a unique individual assignment, and with an optional four digits for security.

The back side of the pendant may comprise a text “for finder's reward or registration please go to www.swissfinder.com or call swissfinder service: +41.84.000.000.1 partner with XYZ”. “XYZ” may denote a partner company, for instance a delivery service company or a company providing or manufacturing and selling the object which shall be protected together with the identification item. Alternatively, the text may be “If Found, & For Finder Reward Go To . . . ”.

A sticker as an another exemplary embodiment for the identification item may comprise the following components:

A foil made of a tamper-evident material which destroys itself automatically when someone attempts to remove the foil from the object. This material is offered by the company 3M, for instance. Furthermore, a holographic layer may be provided on the sticker to protect the sticker against imitations.

Furthermore, the sticker may comprise the following inscription:

Inscription “Ident. No.” and “Auxiliary number” (Aux. No.) or “Verification number” (Verif. No.)

Inscription of a, for instance, nine to ten digit alphanumerical combination.

Inscription “item. registered item.registered” (or similar)

Inscription “www.swissfinder.com”

Inscription label (for instance “swiss finder”).

Another embodiment of the identification item is a label which may be connected to the object by ironing, or a text on a garment (like a T-shirt). The information may then be printed on the garment. The label may be connected to a garment or fabric by means of ironing, sewing, or the like. Registration may be carried out in a similar manner as in the case of a sticker which may be adhered to the object.

When the information of the identification item is provided on a garment (for instance a T-shirt), the user may use this garment and may register herself or himself as a person so that this person can be found (for instance in the context of the services of a dating agency).

The (key) pendant can be arranged as a marking on a key ring or bunch of keys. Afterwards, the user may register the identification number on the homepage “www.swissfinder.com” in a “register” or “activate” menu by inputting the ten digit alphanumeric number/letter combination, the object (bunch of keys, mobile phone, laptop), the name, and other personal data.

In case the bunch of keys is lost and a finder (for instance motivated by the finder reward) reports that the keys have been found under “www.swissfinder.com” or under the telephone number +41.84.000.000.1, the central computer authorizes the delivery service to pick up the keys at the finder's position or location. Afterwards, the keys are brought to the user who has lost the keys, that is to say the registered owner. Optionally, the user (or owner) may be informed (for instance via a text message like an SMS, an email, a telephone call, a fax, etc.) that the keys have been found.

The sticker may function according to the same principle. The sticker (for instance of a tamper-evident material) can be adhered onto the object to be registered to mark the object (for instance cellular phone, laptop, MP3 player, digicam, videocam, DVD portable, etc.). The number-letter combination on the sticker may be registered in the same manner as the key pendant. The finder may proceed as described above. However, it is possible that the costs for transporting back are charged in the amount of a particular sum, for instance 20 Euro or 40 Euro.

Therefore, practically any object which is marked with a finder system pendant or sticker can be assigned to a person without the possibility of any third person reconstructing this assignment. With the identification number, the marked objects remain anonymous, but are registered and are identifiable in the case of loss or theft. This may guarantee anonymity.

With such a system, the following additional benefits may be simultaneously achieved.

For the user, security is improved. With a finder system, it can be ensured that the lost object is returned to the user, if the finder decides to report finding or to report the object. This service may be free of charge for the user.

Furthermore, the information collected in the database may be used for a statistical analysis or for marketing purposes.

The reliance relationship between the user and the finder system may increase the willingness of the user to renew or refine the data provided as the user data.

Thus, an anonymous finder system is provided in which a finder does not know anything about the user or the owner of the object. However, when the finder informs the finder system that she or he has found the object, this information may be conveyed to the user (for instance via text message, email, telephone call or fax). The user may then decide whether the delivery service should be instructed to bring back the object, or not. Such an anonymous finder system may have the advantage that any blackmail may be prevented, since the finder does not have the address information of the user.

However, in an only partially anonymous system, a finder may request information regarding a user. In such an embodiment, the user may be informed and has to agree before the finder is provided with the user information (like address). In such a scenario, the anonymity may be lost. On the other hand, this may allow the user to pick up the lost item on her or his own, without the need of a separate delivery service. Or, the information may be used by the finder to organize the delivery. An example of such a scenario is an airline. When the airline (the term “airline” may cover everything and everybody working on an airport and/or having access to luggage within an airline cycle, particular an airline company, airline staff, ground handling agents, airport authority, etc.) finds bags or other traveller's equipment (equipped with an identification tag) and cannot assign it to the owners, the airline may access an Internet page of the finder system, after an authorization. The finder system may then provide the user information to the airline in response to receipt of the identification information of the identification tags. The airline may then directly contact the users and may offer them transport and delivery of the traveller's equipment.

According to all exemplary embodiment of the invention, the system may be always anonymous with the exception of an upstream legitimation procedure. Such a legitimation procedure may be performed simultaneously with the sending of inverse information. In other words, data from the legitimation/authorization procedure are provided to the user when the legitimation/authorization procedure is finished. Such data may be stored in a (“Swiss Finder”) database. According to such an embodiment, notice of the data before the legitimation/authorization procedure may be made impossible. Only afterwards, the sensitive data are accessible, for instance for medical staff or other finder/person groups.

According to another aspect of the invention, an arrangement and a method of providing a finder of an identification item with user data is provided. In this context, a user identifies himself or herself in connection with a unique identifier of all identification item, like a key ring pendant or the like. While carrying out the registration, which may be performed via the Internet, the user may provide a database with medical data of the user which may be of interest in a medical emergency in a scenario in which the user has had an accident, such as a car accident, and is not capable of communicating the medical data of the user (e.g. blood group) to a physician. When such an accident actually happens, the physician called in a medical emergency may find the user in her/his car, and may find the key ring pendant or sticker with an inscription like “Emergency Finder” or “Rescue Finder”. From this identification item, the physician may read the unique identifier and may call a central station of the data management system. This data management system may then provide the physician with the medical user data which may allow the physician to take the correct actions to save the life of the user.

Such a data management system may be operated by an emergency medical service corporation or by an automobile association. The user data may also be used for marketing purposes.

In such a scenario, an operator (e.g. an emergency medical service corporation or an automobile association) may distribute identification items to their members. In an emergency case, for instance an accident or when a person is committed to a hospital, the operator may receive medical related data (or any other useful data) from the database in which the members have registered themselves in connection with the identifier of the identification item, while supplying the database with the user data. Authorization to gain access to the data may be restricted to a scenario in which the user has agreed beforehand that the user data may be accessed by a physician in case of an emergency. The authorization to access the data may be restricted to an emergency case.

It is also possible to attach the identification item to a door (for example the exterior side of a door) of a user's flat, for instance of an elderly user. In a medical emergency a rescuer may then have fast access to user related medical data by accessing the database with the unique identifier attached to the door and the procedure described above. This may make it unnecessary for a physician to perform a time-consuming diagnosis before taking necessary emergency actions as the physician can be informed by the data management system according to the embodiment of the invention with respect to a user's medical history. This may save valuable time in saving the life of the user.

With regard to this case it should be noted that emergency medical service corporations normally have an internal communication system (for instance a radio communication system) or a mobile phone (like a WAP phone) which may be connected to the database to provide the data more quickly.

Next, further exemplary embodiments of the invention will be described.

In the following, exemplary embodiments of the arrangement for delivering a lost object to a user will be explained. However, these embodiments also apply to the method of delivering a lost object to the user and to the arrangement and the method of providing a finder of an identification item with user data.

The control unit may comprise a computer and/or a call center. Thus, a central instance may be provided by which the registration may be performed and which may, in the event the object is found by a finder, coordinate further measures taken.

The control unit may be accessible to the finder via at least one of the group consisting of a computer network, a telecommunication network, and a postal service network. In other words, the finder may access the control unit via the Internet, a telecommunication network (for instance by calling a call center), or by simply putting the object into a mailbox so that the object will be brought to the user by the postal service or the operator or the headquarters of the finder service of the arrangement for delivering the lost object to the user.

The database may be stored on a storage device. Such a storage device may be, for example a hard disk or a CD or DVD. The storage device may be rewritable so as to enable an update of the user data. The memory management of such an update system may be a ring buffer.

The delivery service may be a shipping service provider. Such a shipping service provider may offer the service to (internationally) transport any object to any location.

The identification item may be one of the group consisting of a pendant, a label, a sticker, a tag, a garment, and a patch. In other words, the identification item may be any physical element on which the identification information may be provided, for instance engraved or inscripted. However, also non-material indicia like an inscription or an engraving are possible embodiments of the identification item.

The identification item may be adapted to be collected to the object by at least one of the group consisting of mechanically connecting, adhering, sewing, wearing, or ironing. For instance, a key ring connected to keys may also be connected to the identification item. A sticker may be adhered to a device like a laptop. A label may be sewed onto a garment. A garment inscripted with the unique identification information may be directly worn by a human user. A tag may also be ironed onto the object, for instance ironed onto a garment.

The identification item—only stickers not tags—may be destructible when being removed from the object. By taking this measure, misuse may be avoided.

The identification item may be forgery-proof. For instance, measures like providing a hologram on the identification item may improve security.

The unique identification information may be an alphanumerical code or a (machine-readable) bar code. In other words, such a code may comprise letters and numbers.

The user data may comprise at least one of the group consisting of a name of the user (first name and/or last name), profession of the user (or a branch in which the user is working), income of the user (which may be grouped into different income groups), an age of the user (which may also be grouped into different age groups), an address of the user (including city, country, telephone number, email address, fax lumber, etc.), a personal preference of the user (for instance hobbies), and the family relationship of the user (married, divorced, single, number of children, etc.).

The lost object may be at least one of the group consisting of a key, a laptop, a cellular/mobile phone, a portable entertainment device (for instance an MP3 player), a bag (for instance a backpack, a purse, an executive case, a trolley, a handbag, a baggage item, a luggage item, a container, a box, a trailer, a case, a crate, a pouch), an animal (for instance a dog, a cat, a bird, a reptile, a horse, a cow, a goat, a sheep, a fish, a whale, a dolphin, livestock, a cattle), a pet, an object of art, a wooden object (for instance any plant, or wooden logs from endangered trees), a gear (for instance for army, sport, technical purposes), and a person (that is to say a human being who may also get lost, for instance a child, a member of an army, an inmate, a passenger).

The above list of animals is only exemplary. Any animals, for instance endangered species or pets, may be found using the finder system. For example, when tagging a whale or an elephant with an identification tag (like an RFID tag), such an animal can be traced and can be registered, for instance in a medium being internationally accessible.

Any plants may be tagged. For example, mahogany trees may be tagged. Also, cutover wood may be tagged. By such tagging, it may be prevented that plants are used in an illegal manner.

The identification item may include a message promising a reward to the finder in case the finder notices that the finder has found the object connected to the identification item and provides the unique identification information. By promising a finder reward to a potential finder, the motivation for using the finder system may be improved.

The identification item may comprise a radio-frequency identification tag (RFID tag). An RFID tag may comprise a semiconductor chip (having an integrated circuit) in which data may be programmed and rewritten, and a high frequency antenna matched to an operation frequency band used (for example 13.56 MHz, or a frequency band of 902 MHz to 928 MHz in the United States, a frequency band of 863 MHz to 868 MHz in Europe). Besides the RFID tag, an RFID-system may comprise a read/write device and a system antenna enabling bi-directional wireless data communication between the RFID tag and the read/write device. Additionally, an input/output device (e.g. a computer) may be used to control the read/write device. Different types of RFID-systems are distinguished, namely active RFID-systems (having their own power supply device included, for example a battery) and passive RFID-systems (in which the power supply is realized on the basis of electromagnetic waves absorbed by a coil and an antenna, respectively, wherein a resulting alternating current in the antenna may be rectified by a rectifying sub-circuit included in the RFID-system to generate a direct current). Moreover, semi-active (semi-passive) systems which are passively activated and in which a battery is used on demand (e.g. for transmitting data) are available.

The control unit may be adapted to inform the user that the finder has found the object. This information may help the user to avoid unnecessary steps which may become obsolete since the object has been found.

The control unit may further be adapted to inform the user about an identity of the finder who has found the object. This may simplify the transport of the object back from the finder to the user. Further, the knowledge of the finder's identity may make it simpler for the user to judge reliability of the finder and to decide whether further steps are necessary or not.

Referring to the two previously described embodiments, the control unit may inform the user via a text message, an SMS, an MMS, an email, a telephone call, a letter, and/or a facsimile.

In the following, exemplary embodiments of the method of delivering a lost object to a user will be explained. However, these embodiments also apply to the arrangement for delivering a lost object to a user and to the arrangement and method of providing a finder of an identification item with user data.

The object may be delivered to the user without charging the user. In the context of such a free of charge finder system, the willingness of the user to use the finder system and to provide the user data of interest may be increased.

The method may further comprise providing the user data to a company for marketing purposes. Thus, for a company, the user data input during registration may be interesting for marketing purposes.

Furthermore, the method may comprise informing the user that the finder has noticed that the finder has found the object connected to the identification item. Thus, at a very early stage, the user can be informed (via text, email, fax, phone, etc.) that the object has been found (particularly if the user had agreed the service before) and is on the way back.

The object may be delivered to the user by a delivery service after picking up the object by the delivery service from the finder. In this embodiment, the person or organisation of the finder on the one hand and of the delivery service on the other hand may differ.

Alternatively, the object may be delivered to the user by the finder. In this embodiment, the person or organisation of the finder on the one hand and of the delivery service on the other hand may be identical. Particularly, when the finder is an airline, it may be appropriate that the airline itself delivers found traveller's equipment back to the user, after having received information regarding the owner of the traveller's equipment form the control unit of the finder system.

In the following, exemplary embodiments of the arrangement of providing a finder of an identification item with user data will be explained. However, these embodiments also apply to the method of providing a finder of an identification item with user data, and to the arrangement and the method of delivering a lost object to the user.

The control unit may be adapted to provide the finder with the user data only if the user has agreed to provide the finder with user data in case the finder has noticed that the finder has found the identification item. For example, when the user registers herself/himself in the database, the user may be asked to approve that medical data may be provided to a physician in an emergency case.

The control unit may be adapted to provide the finder with user data only in an emergency case, particularly in case of an accident or in a medical emergency. Such an emergency may be a car accident, a spots accident or a work-related accident. Furthermore, committing the user to a hospital may be considered an emergency case as well.

The control unit may be adapted to provide the finder with user data only if authorization has been granted to the finder by the user during the registration process. For example, a group of finders may be registered or defined in the database who are deemed to have authorized access to the user's medical data. For example, all physicians working with an emergency medical service corporation may potentially be granted authorization through this registration.

Particularly, the user data may comprise medical information related to the user. Such medical information may comprise at least one of the group consisting of an image showing the user, the blood type of the user, a disease the user may have, (e.g. AIDS, diabetes), an allergy the user may have, an allergy to a medication, information regarding a medication which must be administered to the user (e.g. insulin), information regarding possible organ donation of the user, and any of the user's medical emergency related information, (i.e. any parameter of interest in case of an emergency).

The control unit may be accessible to the finder via at least one of the group consisting of a computer network, a radio communication network and a telecommunication network. For example, an emergency medical service corporation may use its own internal (radio) communication system.

An object to which the identification item may be connected may be at least one of the group consisting of a car, a door of an apartment or a house, a key, a laptop, a motorcycle helmet, a crash helmet, a phone, a portable entertainment device, a suitcase, diving equipment, a travelers device, a credit card, and a person. Particularly, the identification item may be connected to any object which is likely to be noticed or found by an emergency medical service in case of an emergency.

The control unit may be adapted to inform the user (including reverse information about a legitimation/authorization procedure) that the finder is provided with the user data (before or after transmitting the user data to the finder), for instance via a text message, an SMS, an MMS, an email, a telephone call, a letter, and/or a facsimile. This may ensure privacy and may avoid misuse of the system.

In the following, exemplary embodiments of the method of providing a finder of an identification item with user data will be explained. However, these embodiments also apply to the arrangement for providing a finder of an identification item with user data and to the arrangement and method of delivering a lost object to a user.

The finder may be provided with the user data only after having performed a successful legitimation procedure. For example, in case of a human emergency, a physician or another person related to authorized medical staff has to become authorized before getting access to medical data of a user. This may ensure that confidential personal information is provided only to authorized persons. A corresponding authorization procedure may include the answer to one or a plurality of questions (for instance with regard to a hospital to which the finder belongs, a name of the finder, a telephone number, etc.).

In the following, an example of a legitimation procedure will be explained. Emergency case data can only be accessed in case the user has agreed to the accessibility during registration and in case the finder (a physician or a member of a medical staff) has proven his or her authorization before getting access to the user data. Such a legitimation procedure may include answering questions. The answers to the questions may be emailed to the user so that the user can understand at any time who has access at which time to which information, where and why. This may allow detection of misuse.

The method may comprise informing the user that the finder will be (in the future) or has already been (in the past) provided with the user data. After having provided a finder with data of the user, the transmission of this user information may be brought to the attention of the user. By taking this measure, a further control mechanism is triggered to ensure that non-authorized people do not get access to the user data. Alternatively, a further control mechanism is triggered to ensure that non-authorized people, even when the get access to the user data, can be traced.

The aspects defined above and further aspects of the invention are apparent from the examples of embodiment to be described hereinafter and are explained with reference to these examples of embodiment.

The invention will be described in more detail hereinafter with reference to examples of embodiment but to which the invention is not limited.

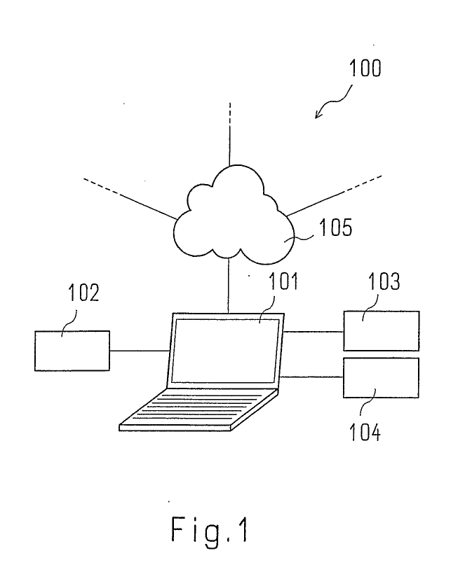

FIG. 1 shows an arrangement for delivering a lost object to a user according to an exemplary embodiment of the invention in a first operation state.

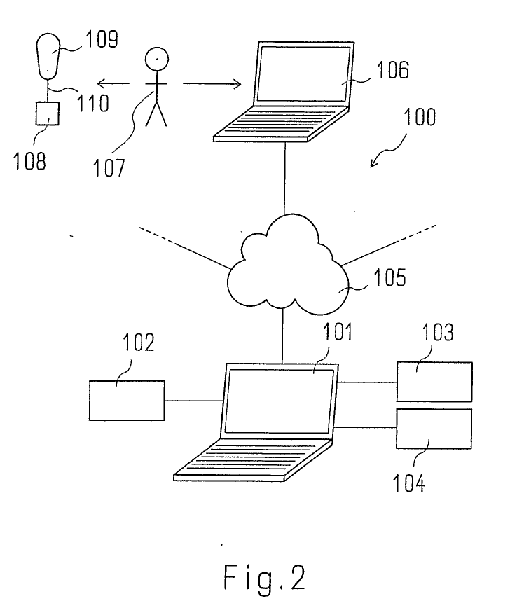

FIG. 2 shows the arrangement for delivering the lost object to the user according to the exemplary embodiment of the invention in a second operation state.

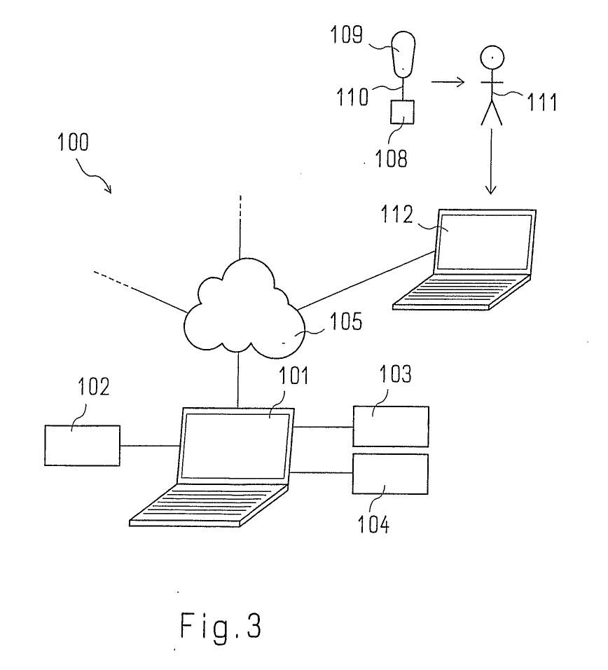

FIG. 3 shows the arrangement for delivering the lost object to the user according to the exemplary embodiment of the invention in a third operation state.

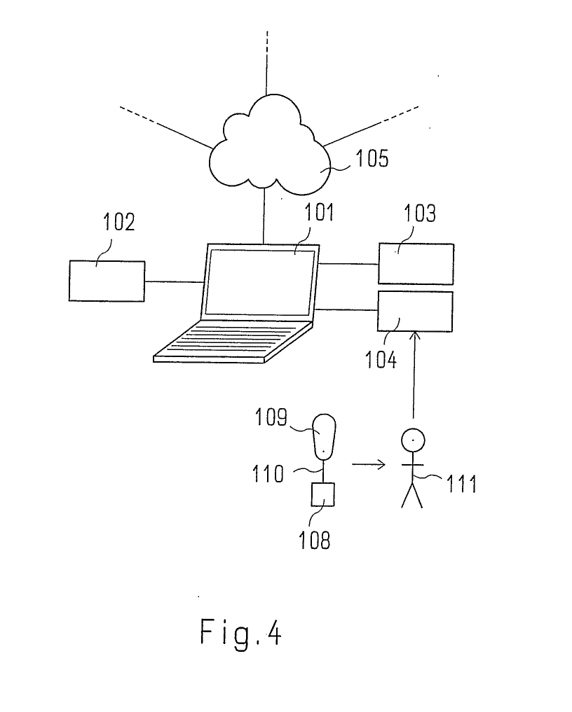

FIG. 4 shows the arrangement for delivering the lost object to the user according to the exemplary embodiment of the invention in a fourth operation state.

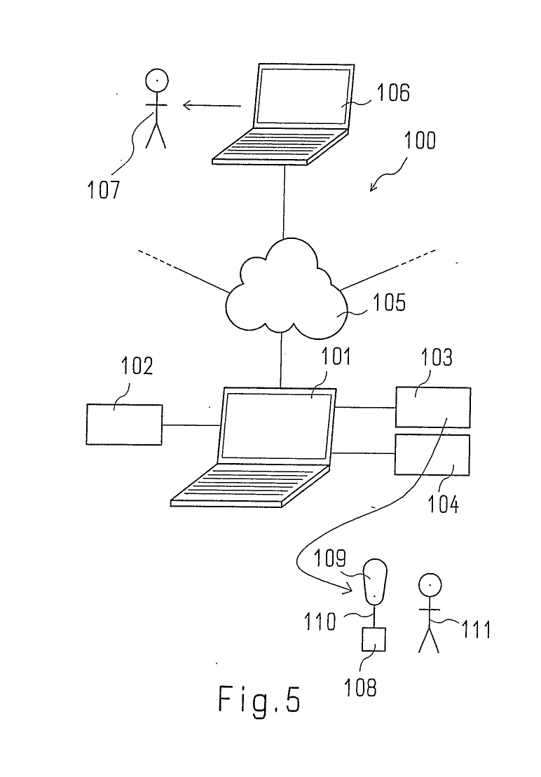

FIG. 5 shows the arrangement for delivering the lost object to the user according to the exemplary embodiment of the invention in a fifth operation state.

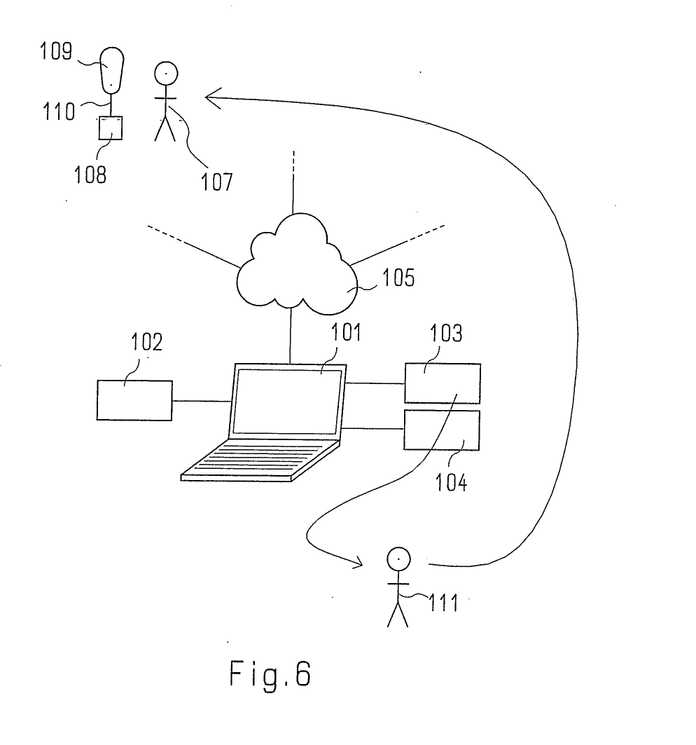

FIG. 6 shows the arrangement for delivering the lost object to the user according to the exemplary embodiment of the invention in a sixth operation state.

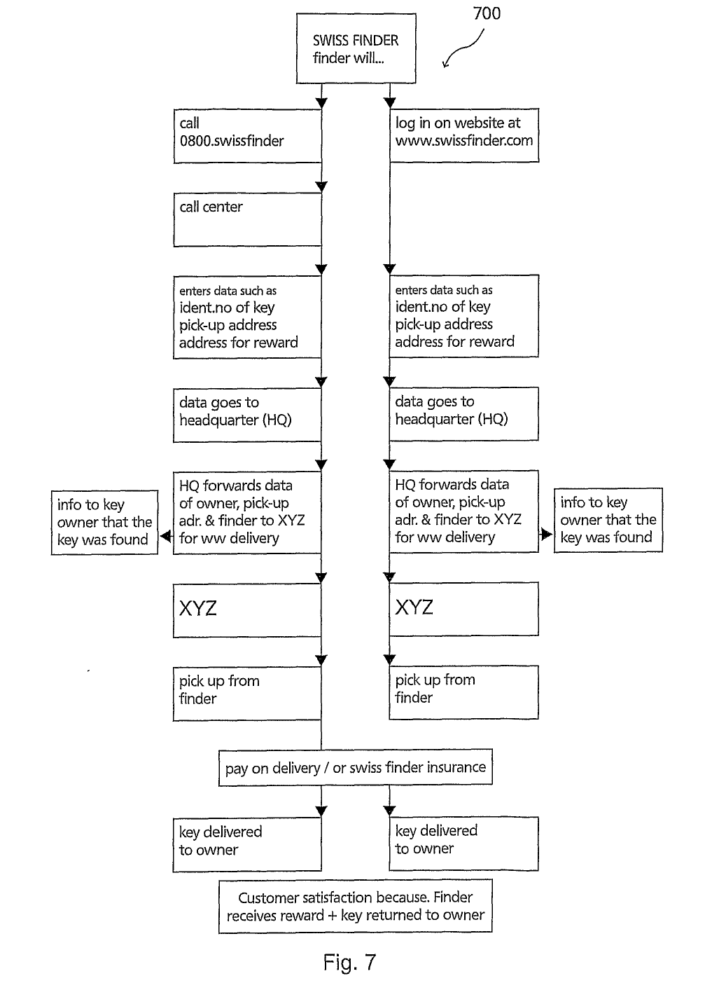

FIG. 7 shows a flow chart illustrating a method of delivering a lost object to a user according to an exemplary embodiment of the invention.

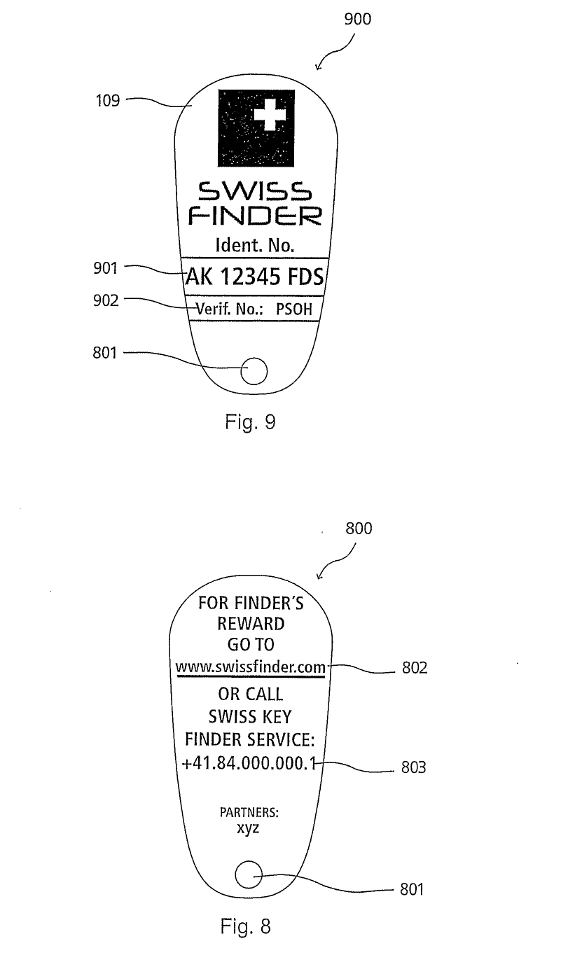

FIG. 8 shows a back side of an identification item according to an exemplary embodiment of the invention.

FIG. 9 shows a front side of the identification item according to the exemplary embodiment of the invention of FIG. 8.

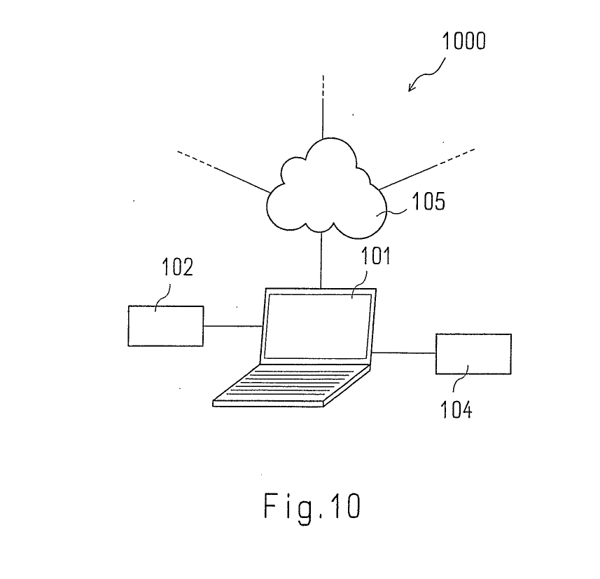

FIG. 10 shows an arrangement for providing a finder of an identification item with user data according to an exemplary embodiment of the invention in a first operation state.

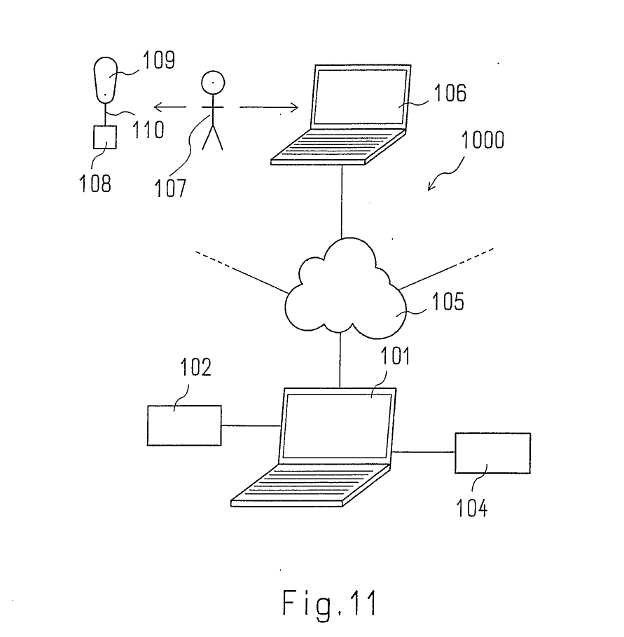

FIG. 11 shows the arrangement for providing the finder of the identification item with the user data according to the exemplary embodiment of the invention in a second operation state.

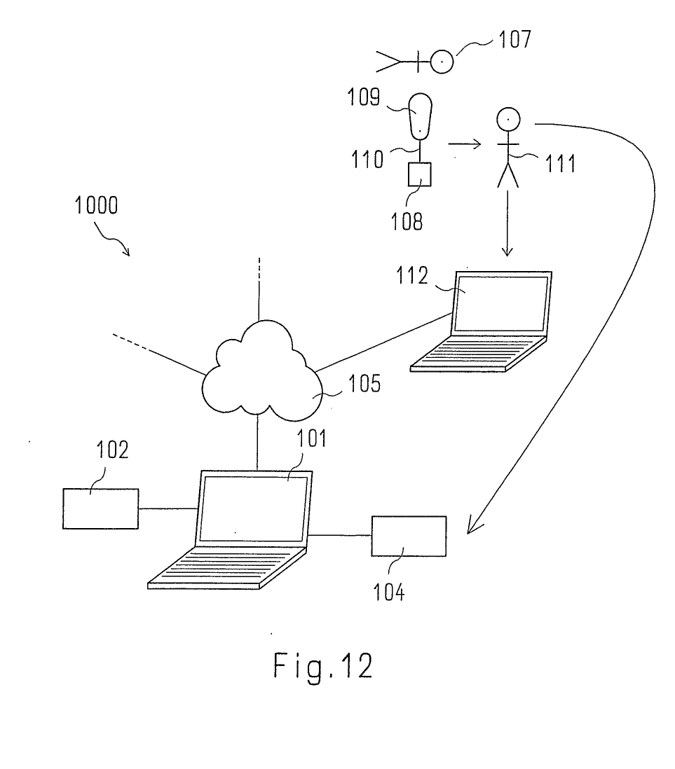

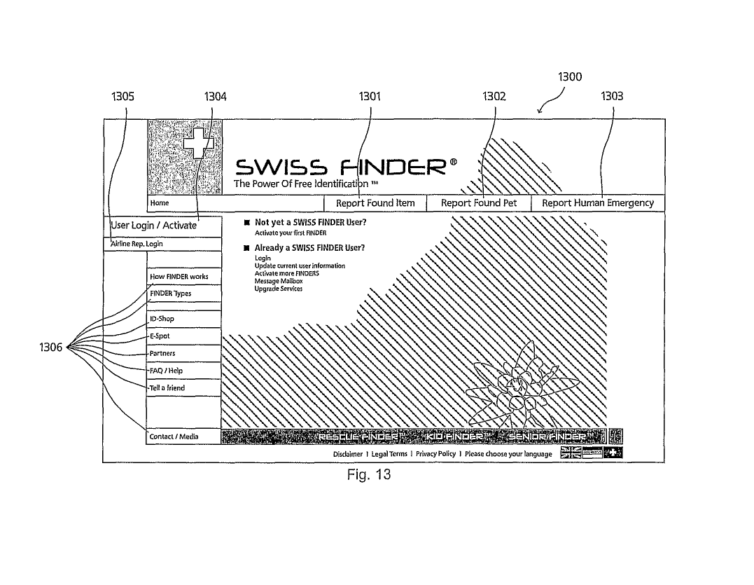

FIG. 12 shows the arrangement for providing the finder of the identification item with the user data according to the exemplary embodiment of the invention in a third operation state.

FIG. 13 shows a screen shot of an Internet page being part of an arrangement for delivering a lost object to a user according to an exemplary embodiment of the invention.

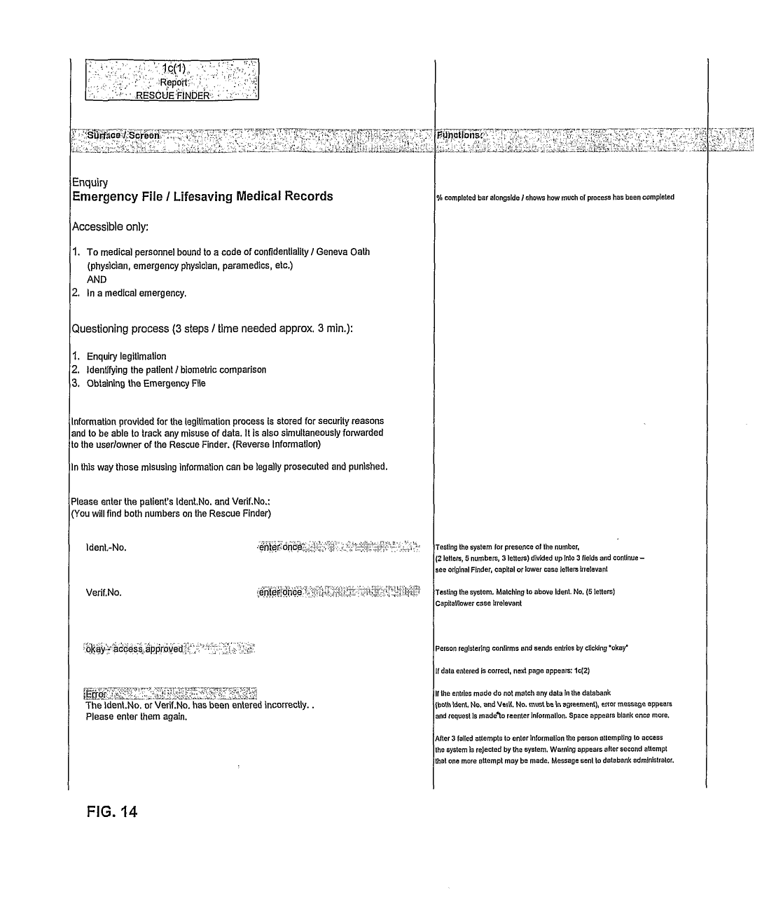

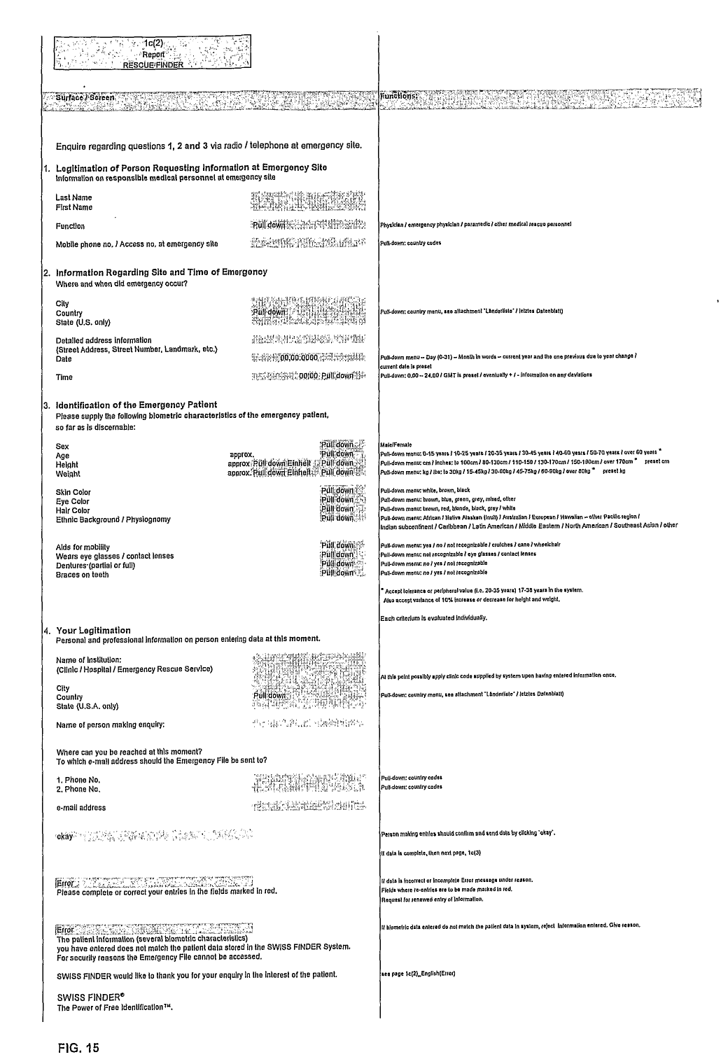

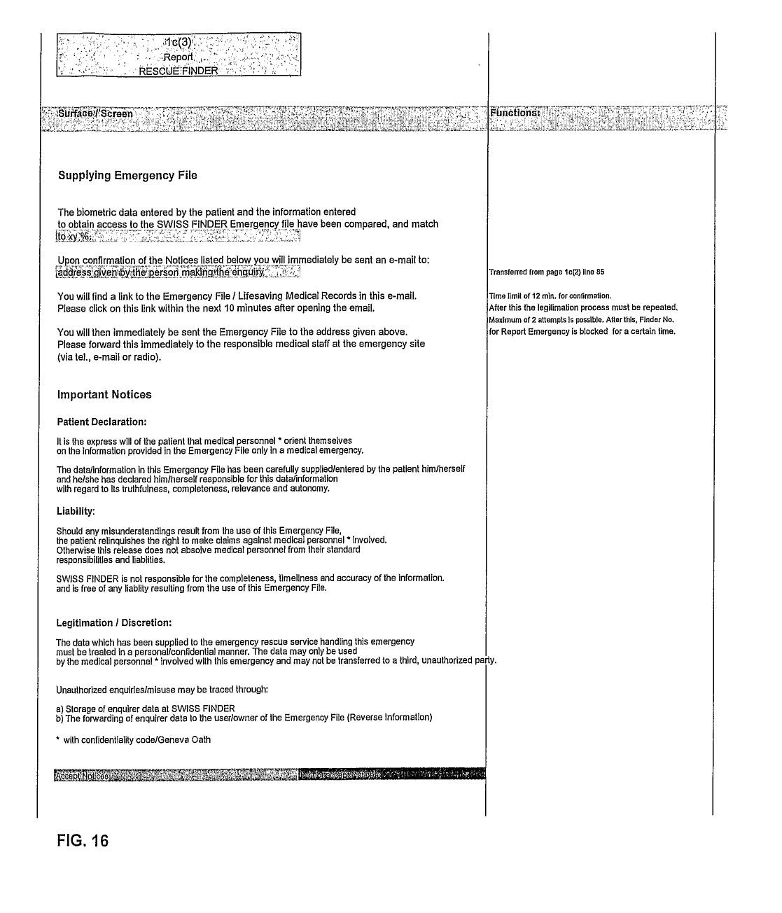

FIG. 14 to FIG. 16 show a legitimation procedure for a rescue finder system according to an exemplary embodiment of the invention.

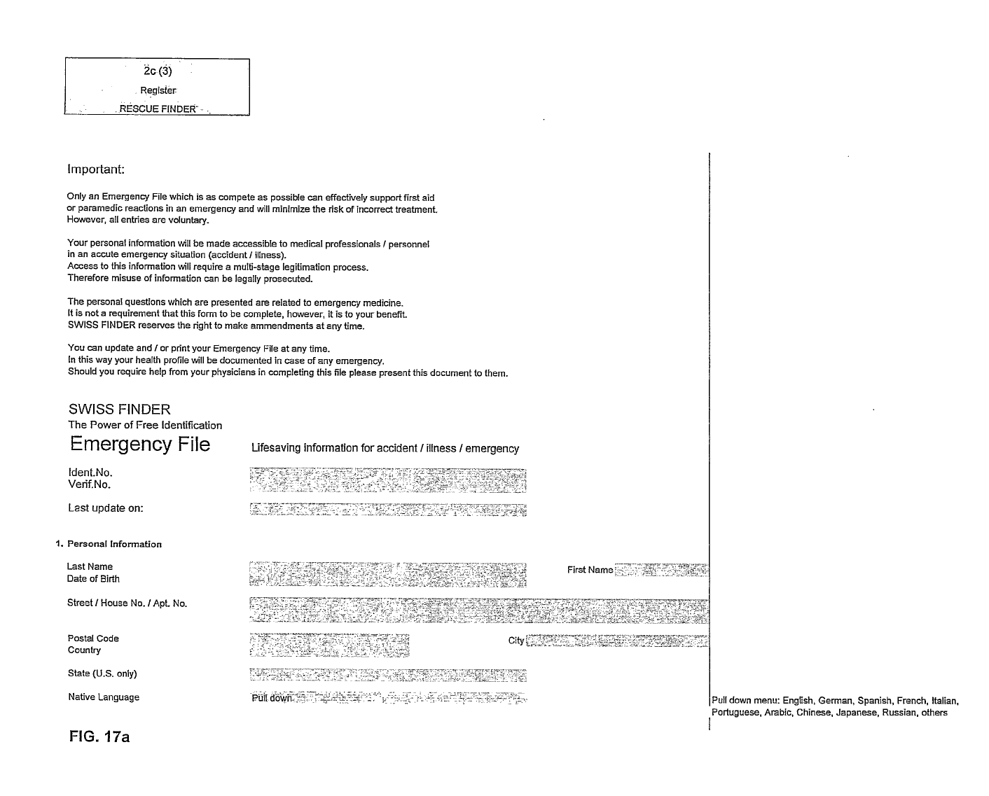

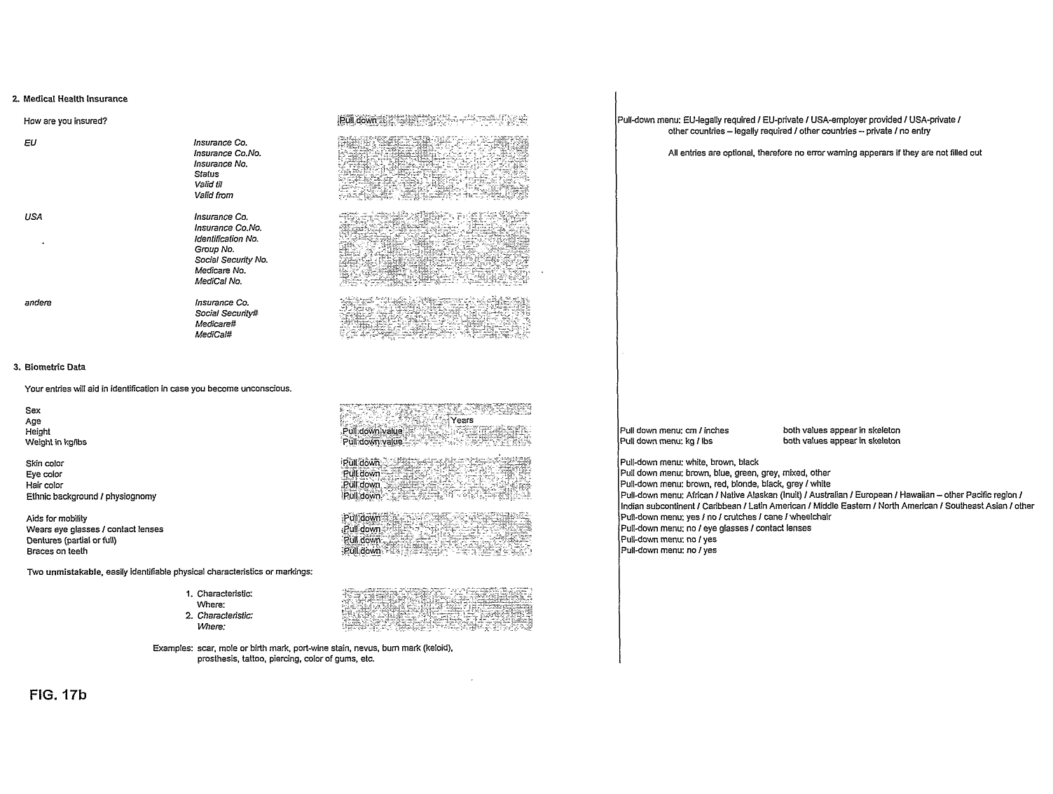

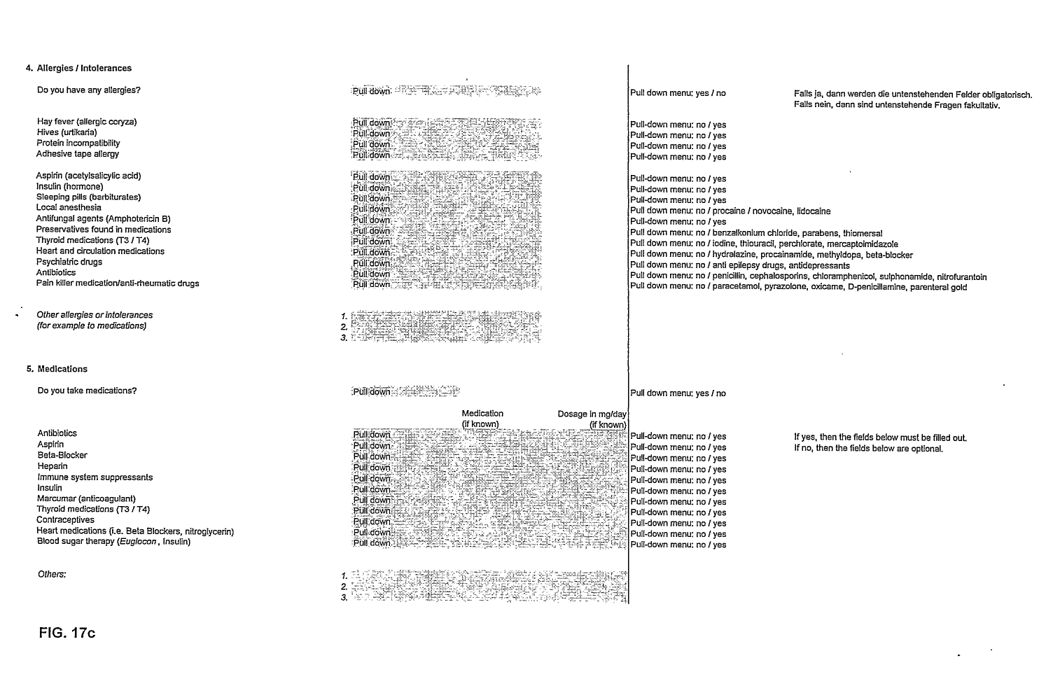

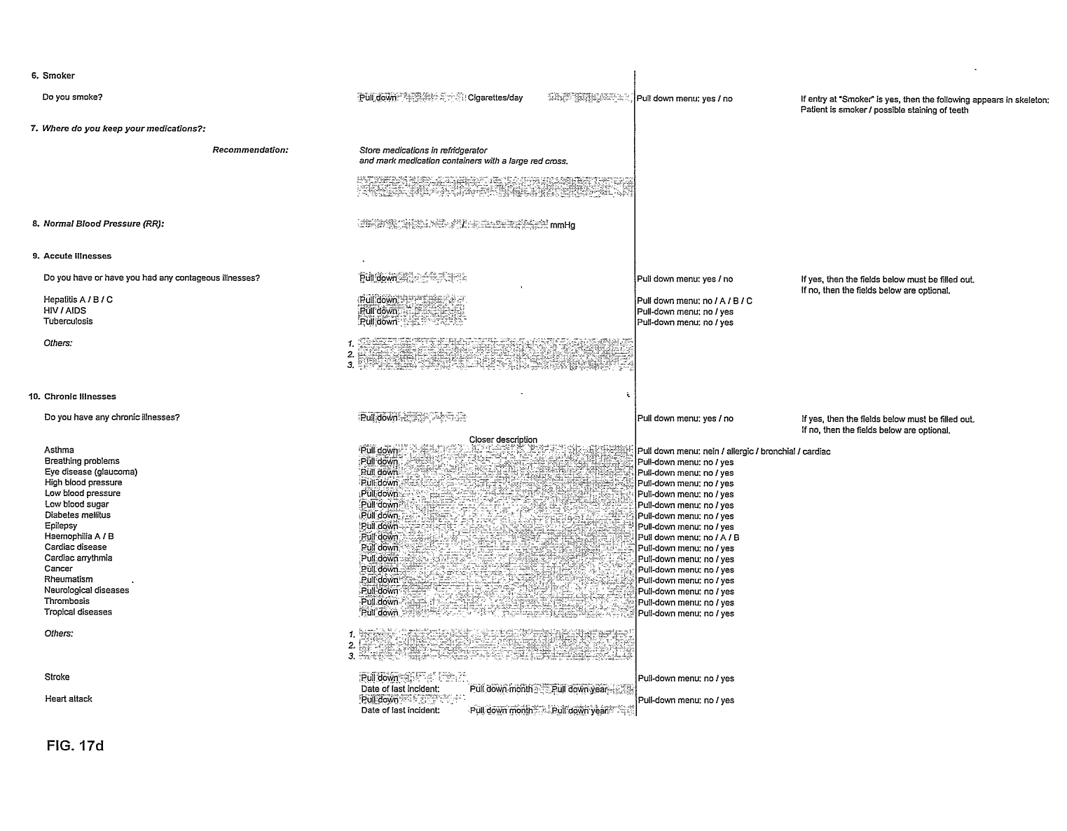

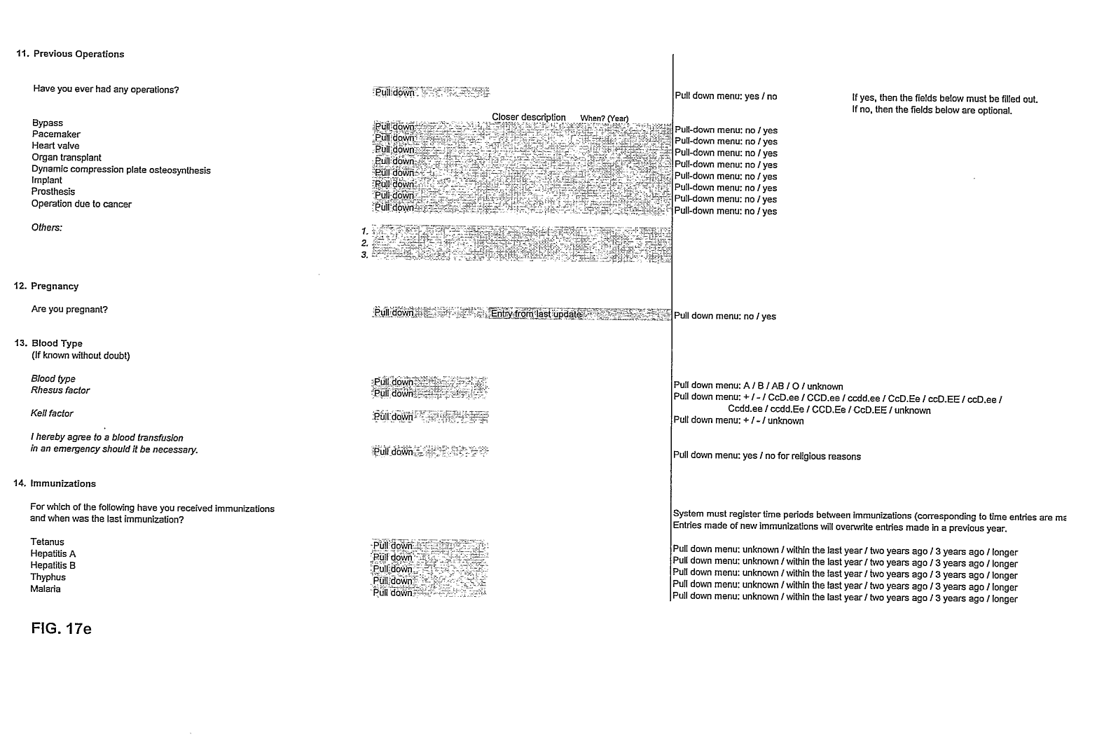

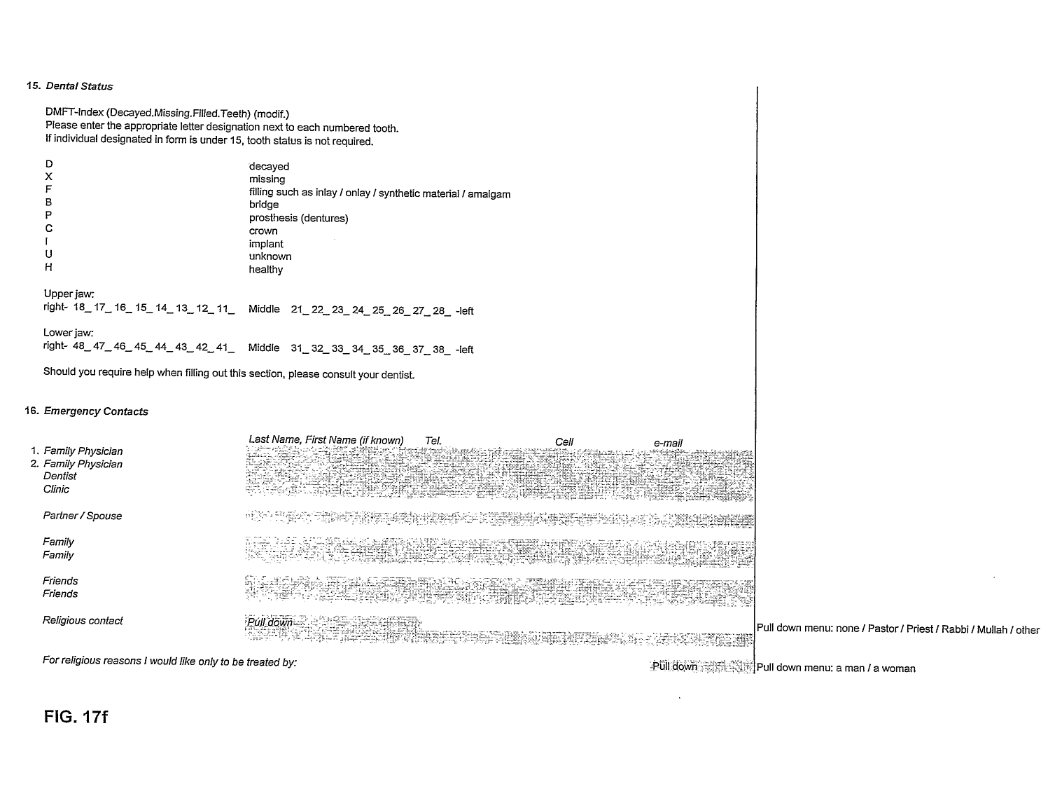

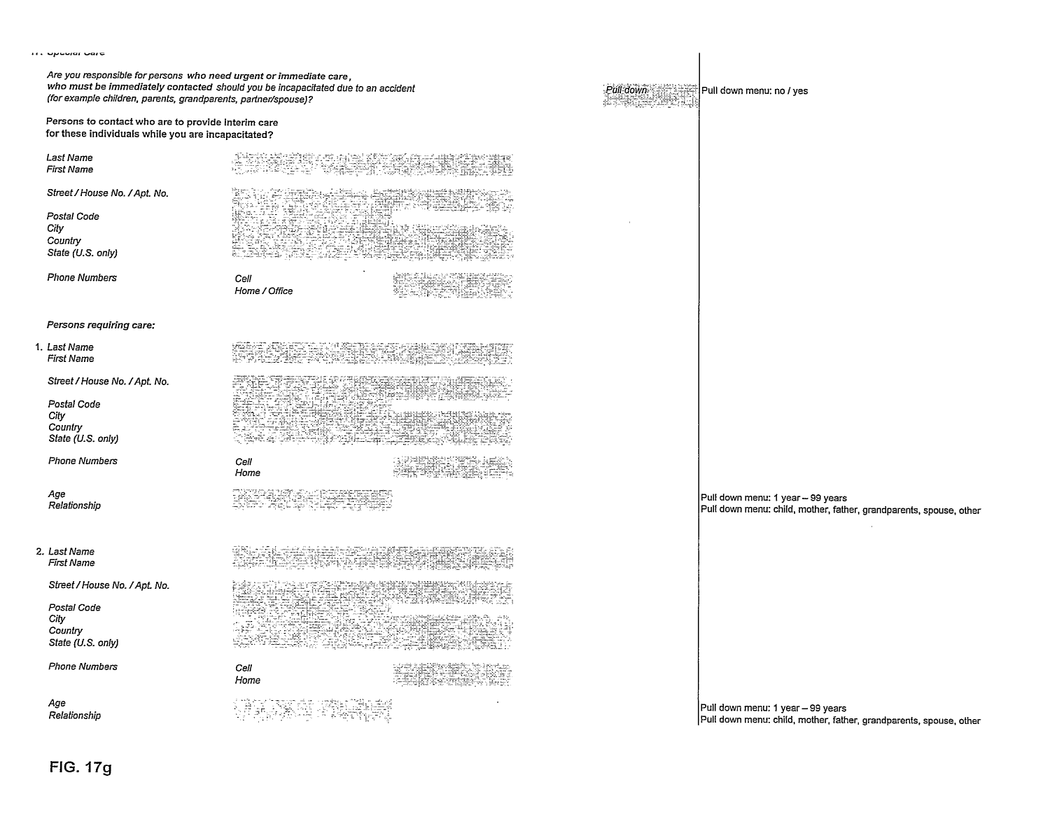

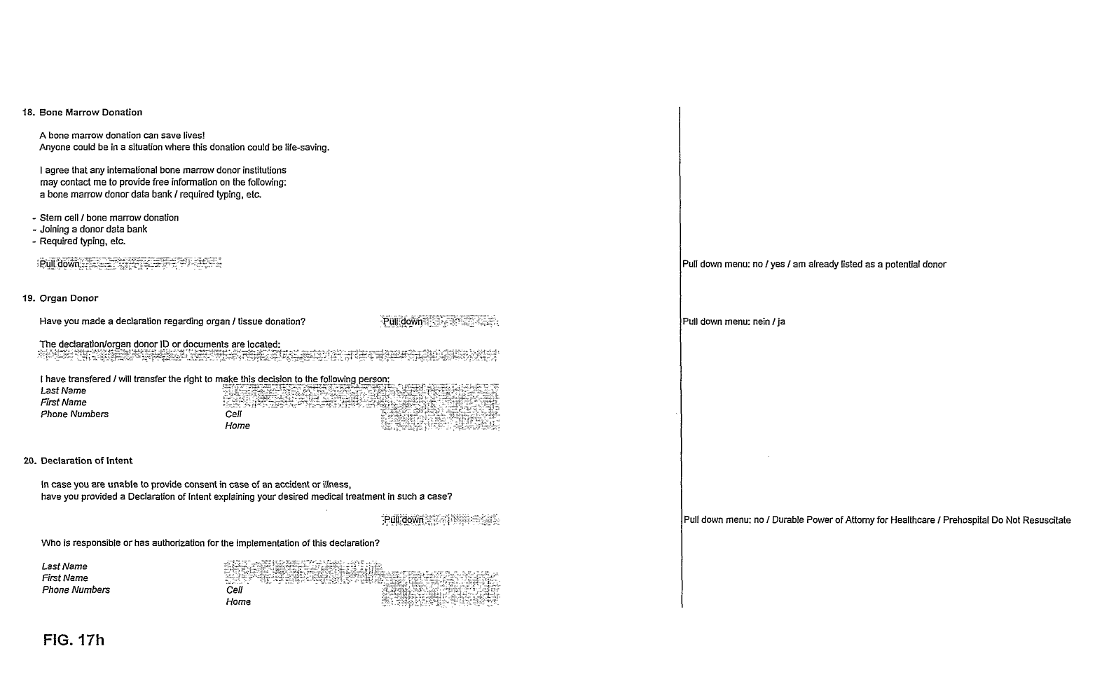

FIG. 17A to FIG. 17I show an emergency file for a rescue finder system according to an exemplary embodiment of the invention.

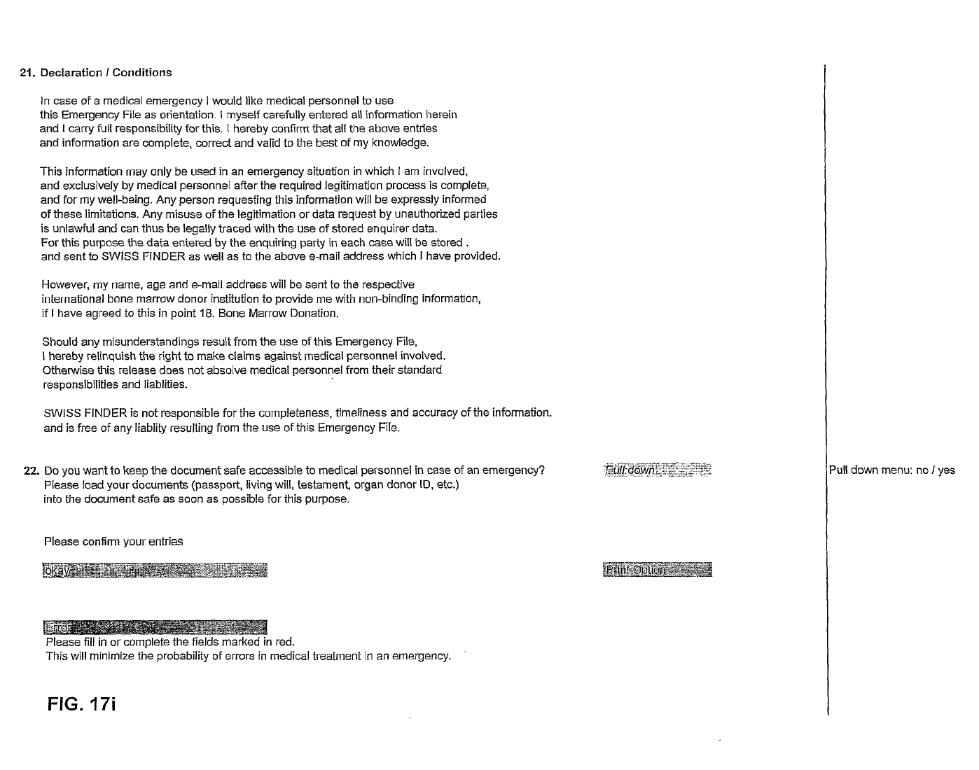

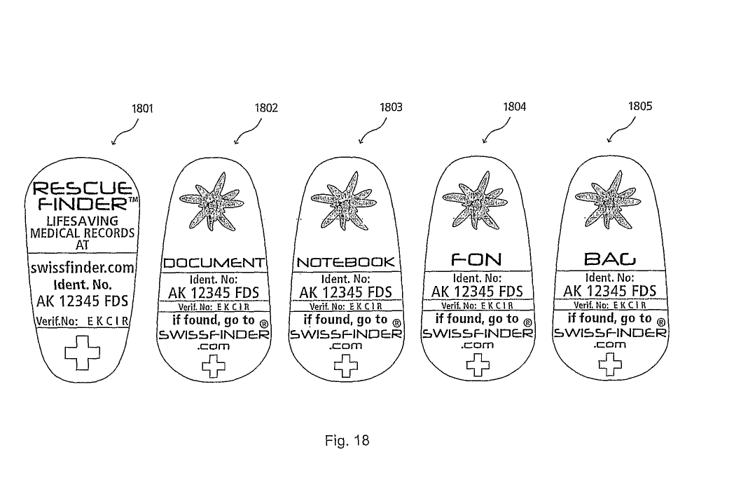

FIG. 18 shows stickers as identification items according to an exemplary embodiment of the invention.

The illustration in the drawings is schematical. In different drawings, similar or identical elements are provided with the same reference signs.

The following diagrams, FIG. 1 through FIG. 9, describe an arrangement 100, for delivering a lost object to a user according to an exemplary embodiment of the invention.

The arrangement 100 comprises a server computer 101, a storage unit 102 including a database, a delivery service unit 103 and a call center 104.

As can be seen from FIG. 1, the server computer 101 is connectable via the Internet 105 to any other computer connected to the Internet 105. Furthermore, the server 101 has access to the database 102, can communicate with the delivery service unit 103 and can also communicate with the call center 104.

FIG. 2 shows the arrangement 100 in a second operation state.

In this operation state, a client computer 106 (or any other computer) is connected via the Internet 105 to the server computer 101. The client computer 106 may be operated by a user 107 of the finder system shown in FIG. 1 and FIG. 2. In the context of this finding system, an object 108, for instance a key, has been connected by the user 107 with an identification item 109. Although not shown in FIG. 2, the identification item 109 comprises an alphanumeric code as unique identification information.

FIG. 2 shows a connection 110 between the object 108 and the identification item 109. This connection can be a mechanical connection like a connection of the identification item 109 with a key ring of the key 108.

When the user 107 wishes to register in the server computer 101 that she or he has connected the object 108 to the identification item 109, then the user 107 may access the database 102 via the client computer 106, the Internet 105 and the server computer 101. The user 107 may provide user data for registering in the database 102 and in the server computer 101 to the connection of the object 108 to the identification item 109. This may include that the user 107 indicates her or his name and further personal data and that the identification item with the corresponding alphanumerical identification code has been connected with the key 108. For registration, the user may log into a homepage of the finding system which may be indicated on the identification item 109.

The correlation between the unique identification information and the provided user information is stored in the database 102.

FIG. 3 shows the arrangement 100 in a third operation state.

In the scenario shown in FIG. 3, the user 107 has lost his key 108 which had previously been connected with the identification item 109 and had been registered in the database 102.

When a finder 111 finds the key 108 connected to the identification item 109, then the finder 111 can gather information inscripted on the identification item 109. This identification information includes a request to give notice to the finder system 100 that the finder 111 has found the object 108 connected to the identification item 109. For this purpose, the server computer 101 can be accessed via a client computer 112 of the finder 111 and via the Internet 105 so that the finder 111 of the object 108 connected to the identification item 109 gives notice, by indicating the unique identification information provided on the identification item 109, that she or he has found the object 108 connected to the identification item 109.

With this information, the server computer 101 may query the database 102 to derive (or collect) information about the identity of the owner and which are the owner data which are uniquely identified with the unique identification information stored in the database 102. Since the user 107 has previously registered the connection of the identification item 109 to the object 108, the database 102 may derive the identification of the owner of the key 108.

FIG. 4 shows an alternative possibility for the finder 111 to give notice that she or he has found the key 108 connected to the identification item 109.

According to this alternative, the finder 111 has called up a telephone number of a call center 104, wherein this telephone number is indicated on the identification item. Via this telephone call, the finder 111 gives notice to a person or to a computer in the call center 104 that she or he has found the key 108 with the identification item 109 by providing the call center 104 with the unique identification information. The call center 104 is coupled to the server computer 101 which may be supplied with this information and may derive the name of the user 107 from the database 102 who is the owner of the key 108 with the attached identification item 109.

Next, as shown in FIG. 5, the central computer 101 gives notice via the Internet 105 to the client computer 106 (or phone or fax) of the user 107 that her or his key 108 has been found. The information necessary for such communication is taken from the database 102 in which the identification information has been stored in accordance with the user data provided beforehand.

Furthermore, the server computer 101 gives notice to the delivery service unit 103 to visit the finder 111 and to collect the object 108 with the identification item 109 provided thereon.

As can be taken from FIG. 6, the delivery service unit 103 then transports back the lost key 108 with the attached identification item 109 to the user 107.

FIG. 7 illustrates a flow-chart 700 of a method of delivering a lost object to a user according to an exemplary embodiment.

The following, refers to FIG. 8, in which the back side 800 of an identification item 109 according to an exemplary embodiment of the invention is described.

The identification item 109 is a metal plate having all oval shape and a hole 801 for attaching the identification item 109 to an object (for instance to a key ring). Furthermore, instructions for a finder who finds the object connected to the identification item 109 are provided on the back side. This includes a URL address 802 and a telephone number 803 which may be accessed by the finder when she or he finds the object with the identification item 109 attached thereto.

As can be taken from FIG. 8, the back side 800 also includes the information “partner with XYZ”, wherein XYZ is a company in partnership with which the finder system is implemented. For instance, the company XYZ may be a company offering or selling the object connected to the identification item 109 or may be the company carrying out the delivery service.

As can be taken from the front side 900 of the identification item 109 shown in FIG. 9, the unique identification information includes all alphanumeric number 901 and a verification number (or an aux. no.) 902. In FIG. 9, the verification number 902 comprises four digits. Alternatively, the verification number 902 may comprise five digits, or more, or less.

In the following, an exemplary embodiment of a worldwide finder system is described.

Any bunch of keys can get lost. The worldwide finder service according to the described embodiment can be adapted to be a key pendant or a sticker. The key pendant may make it possible with the inscription “ident. no.” to find, worldwide, any key in relationship to its owner via an Internet database (or via a single telephone call with the call center), and then to give back the lost key to the user for a finder reward. The finder reward may be an identification item. A more expensive or more valuable finder's fee is possible but may cause the danger of misuse. However, the finder service shall not be misused as a currency equivalent.

Each key (or other traveller's equipment, like a bag, etc.) can be assigned to its owner by means of the key pendant, and any other valuable object, for instance a laptop or a mobile phone can be assigned to its owner by means of a sticker (which may be made of tamper-evident material). After finding and notifying this finding, the object can be brought back to the registered owner. Alternatively, the owner of the object is provided with an information that the object has been found.

Another beneficial consequence of the finder system as a key pendant or as a sticker is in its usage as a Trojan marketing instrument. Thus, client binding may be improved.

A first benefit may be for the user of the finder system in that the subjective feeling of security is improved. The user has a good feeling after having registered the object to be protected in accordance with the unique identification number in the database. This service may be provided, after registration, for a predetermined time period of, for instance, 12 months. The service may be extended in time only after re-registration.

Another benefit of the finder service is that a company may buy a number of identification items which may carry the individual logo or trademark of the client. Furthermore, the logo of the finder system (for instance “www.swissfinder.com”) may be provided on the identification item. Beyond this, an indication for a registration or an activation or finder's reward may be provided on the identification item.

The registration procedure may require the user to input personal data which may then be used for marketing purposes. Furthermore, these data may be used for an assignment, in case of the item is lost, between user and identification item/object.

The customer who has bought a number of identification items may have access to the database segment of its assigned clients who have received an identification item from this customer. As it is necessary for a user to update registration after a predetermined period of time (for instance every 6 or 12 months), it may be ensured that the user data are constantly updated.

The user may receive the identification item as a gift from the company which has bought a number of identification items (for instance when the user has bought a product from this company, or the like).

It may be that the identification items are not available to a private consumer, but can only be given as a gift. For instance, valuable clients may receive such an identification item as a gift. For instance, for a manufacturer of mobile phones, it may be interesting to know current information on their clients. By combining the sale of a new mobile phone with the gift of an identification item (for securing the mobile phone), and by requiring for a user to register before using the identification item, the mobile phone manufacturer may be provided with the desired information.

Other potential clients are airlines, manufacturers of luxury goods, or the like.

After the registration of an identification item, the international server service may be provided for a predetermined time interval of, for instance, 6 or 12 months. After expiry of this period, it is possible to extend the protection by re-registration and/or for a (for instance monthly) fee (for instance 1.2 Euro or 25 Eurocent).

By means of the registration and/or re-registration, it may be ensured that current user data are available to the company.

However, it is possible to register via Internet.

A data mask to be filled out by a user for registration may include at least one of the following items; title, address (private and/or professional), sex, first name, last name, telephone, email, mobile phone number, date of birth, profession, weight, size, hair colour, eye colour, shoe size, etc.

This data may serve to identify the user, for security reasons and for statistical reasons. The client must agree with the standard form contracts or terms and conditions of the finder system and agree to further use of the provided data. Thus, an identification item may be registered. The length of the registration period may be one year or a half year so that the client data do not become outdated. Thus, the data can be, in a short period of time the data can, be efficiently used for company strategy and for evaluating client behaviour. The finder system may ensure database security and provide access only to an authorized person, for instance the corresponding company. For database maintenance and the customer access, the finder system may only be provided for a fee (for instance a fee per identification item and/or per time unit). Stickers may be free of charge.

Database support for a further 6 or 12 months can be maintained for this fee, and delivery service support for transportation of the object (for instance a key) back to the owner may be provided. When a user and/or a client declines use of the service every 6 to 12 months, the finder system (that is the operator or provider) can block the identification numbers to disable the service for the user and/or the client and can offer the finder system service to the customer/user.

According to an alternative embodiment, the identification item may be sold in any shop or only in premium retail stores. The user may then connect the identification item to the object to be protected and register via Internet or call center by inputting the user data in a mask or answering questions from the call center. The data may serve to identify the user, for security purposes and for statistical purposes. The user agrees, for example via Internet, to the standard form contracts or terms and conditions and that the data might also be used otherwise. Then, the identification item is registered. When the object gets lost together with the identification item, the caller calls up the call center or communicates via the finder system homepage (website). In this context, the finder has to indicate the unique identification number, and then the headquarters informs the user who has lost the object with the identification item by SMS, email, telephone, etc. that the object has been found. A pickup service is used for collecting the object with the identification item at the finder's location and to bring it back to the user.

According to an exemplary embodiment of the invention, a system may be provided for managing a pool of devices. For instance, a clinic may own a plurality (many) devices. Each of the devices may be uniquely identified by of engraving numbers or the like. The devices may be assigned to corresponding numbers in a reference table. Then, a device which is needed may be found by means of the unique assignment of number and corresponding device. This example shows that the identification item does not necessarily have to be a physical body or substance, but may also be an (essentially) immaterial component like an imprint or an engraving.

The following diagrams, FIG. 10 through FIG. 12, describe an arrangement 1000 for providing a finder of an identification item with user data according to an exemplary embodiment of the invention.

The arrangement 1000 comprises a server computer 101, a storage unit 102 including a database, and a call center 104.

As can be seen from FIG. 10, the server computer 101 is connectable via the Internet 105 to any other computer connected to the Internet 105. Furthermore, the server 101 has access to the database 102 and can communicate with the call center 104.

FIG. 11 shows the arrangement 1000 in a second operation state.

In this operation state, a client computer 106 (or any other computer) is connected via the Internet 105 to the server computer 101. The client computer 106 may be operated by a user 107 of the finder system shown in FIG. 10 and FIG. 11. In the context of this finding system, an object 108, for instance a key, has been connected with an identification item 109 by the user 107. Although not shown in FIG. 11, the identification item 109 comprises an alphanumeric code as unique identification information.

FIG. 11 shows a connection 110 between the object 108 and the identification item 109. This connection can be a mechanical connection like a connection of the identification item 109 with a key ring of the key 108.

When the user 107 wishes to register the information that she or he has connected the object 108 to the identification item 109 in the server computer 101, then the user 107 may access the database 102 via the client computer 106, the Internet 105 or the server computer 101. The user 107 may provide user data to register in the database 102 and in the server computer 101 to connect the object 108 to the identification item 109. This may include that the user 107 indicates her or his name and other personal data and that the identification item with the corresponding alphanumerical identification code has been connected to the key 108. To register, the user may log into a finding system homepage which may be indicated on the identification item 109.

The user 107 may also provide medical data when registering in the database 102, like an image showing the user 107 (which the user 107 may send to the database 102 as digital data, for example as a jpg-file), the blood type of the user 107, a disease the user may have 107, an allergy the user may have 107, a medication to which the user 107 is allergic, information regarding a medication which must be administered to the user 107 and/or information regarding possible organ donation of the user 107.

During registration, the user 107 may declare that she or he agrees to provide a finder of the user 107 with medical user data in case the finder has noticed that the finder has found the identification item 109, in case of an emergency such as all accident.

The correlation between the unique identification information and the provided user information is stored in the database 102.

FIG. 12 shows the arrangement 1000 in a third operation state.

In the scenario shown in FIG. 12, the user 107 has had an accident and is unconscious.

When a finder 111 (like a physician of an emergency medical service) finds the unconscious user 107 carrying the key 108 connected to the identification item 109 (alternatively, the identification item 109 can be attached to a helmet, a car window, or a house/flat door of the user 107), then the finder 111 can gather information inscripted on the identification item 109. This identification information includes a request to give notice to the finder system 1000 that the finder 111 has found the key 108 connected to the identification item 109, and carried by the user 107 in the present emergency situation. For this purpose, the server computer 101 can be accessed via a client computer 112 of the finder 111 and via the Internet 105 so that the finder 111 of the object 108 connected to the identification item 109 gives notice by providing the unique identification information indicated on the identification item 109, that she/he has found the key 108 connected to the identification item 109 and is being carried by the unconscious user 107. The finder may additionally request medical data of the user 107.

The server computer 101 may check whether the medical data may be provided to the finder 111. The medical data are provided only if the user 107 has indicated—during registration—that the user agrees that the finder 111 is to be provided with the user data in a medical emergency case. If this is the case, the finder 111 is provided with the medical user data.

Based on these medical data, the finder 111 may minimize the likelihood of medical errors or may take the correct actions to help the user 107, without losing valuable time during an unnecessary examination of the user 107.

As an alternative to the communication of the finder 111 via the Internet 105, it is also possible that the finder 111 communicates via radio communication with the call center 104 to obtain the medical data of the user.

The identification item 109 shown in FIG. 12 is a key pendent. Alternatively, the identification item 109 can be a sticker to be attached to a helmet, a car window, or a house/flat door of the user 107. Such a sticker may be employed in any potentially dangerous environment (workplace, apartment, car, motorcycle, cycle, etc.). Particularly, a pendent may be connected to a key, a sticker may be connected to a motorcycle helmet, a sticker may be connected to a bicycle helmet, a sticker may be connected to a house door, a sticker may be connected to a motorcycle, a sticker may be connected to a bicycle, a sticker may be connected to a vehicle (window), etc.

FIG. 13 shows a screen shot 1300 of an Internet page being part of an arrangement for delivering a lost object to a user according to an exemplary embodiment of the invention.

FIG. 13 can be accessed by any person via the public Internet. Using a cursor controllable by a computer mouse or the like, a user may click on a plurality of active buttons of the Internet portal.

By clicking on a Report Found Item button 1301, a finder may report that she or he has found an item, for instance a bag attached to an identification item 800, 900 shown in FIG. 8, FIG. 9.

By clicking on a Report Found Pet button 1302, a finder may report that she or he has found a pet, for instance a dog attached to an identification item 800, 900 shown in FIG. 8, FIG. 9.

By clicking on a Report Human Emergency button 1303, a paramedic may report that she or he has found an injured person, that is a human being attached to or carrying an identification item 800, 900 shown in FIG. 8, FIG. 9.

By clicking on a User Login/Activate button 1304, a user may log into the system or may register herself or himself.

By clicking on an Airline Representative Login button 1305, an employee of an airline may log into the system to report finding one or more traveller's equipment items attached to an identification item 800, 900 shown in FIG. 8, FIG. 9. After authorization, the airline may then be provided with data indicative of the owner(s) of the identification item(s) 800, 900.

Furthermore, information buttons 1306 are provided. When a user clicks on an information button 1306, corresponding information is displayed.

FIG. 14 to FIG. 16 illustrate a legitimation or authorisation procedure for a rescue finder system according to an exemplary embodiment of the invention.

It is also possible that biometric data are provided on the identification item.

FIG. 17A to FIG. 171 show an emergency file for a rescue finder system according to an exemplary embodiment of the invention.

FIG. 18 shows surfaces of stickers as identification items according to an exemplary embodiment of the invention.

More particularly, reference sign 1801 illustrates a sticker for a Rescue Finder (to be attached, for instance, to a helmet, a vehicle or a house door of a person). Reference sign 1802 illustrates a sticker to be attached, for instance, to a document of a person. Reference sign 1803 illustrates a sticker to be attached, for instance, to a notebook of a person. Reference sign 1804 illustrates a sticker to be attached, for instance, to a (mobile) phone of a person. Reference sign 1805 illustrates a sticker to be attached, for instance, to a bag of a person.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

1. An arrangement, comprising
a control unit;
a database;
an identification item;
wherein the identification item comprises unique identification information and is adapted to be connected to an object;
wherein the database is accessible to a user to provide user data for registering the object in connection with the identification item;
wherein the control unit is accessible to a finder of the object connected to the identification item to inform the control unit, based on the unique identification information, that the finder has found the object connected to the identification item;
wherein the control unit or the finder is adapted to instruct a delivery service unit to deliver the object connected to the identification item to the user based on the user data in case the finder has noticed that the finder has found the object.

2. The arrangement of claim 1,
wherein the control unit comprises a computer and/or a call center.

3. The arrangement of claim 1,
wherein the control unit is accessible to the finder via at least one of the group consisting of a computer network, a telecommunication network, and a postal service system.

4. The arrangement of claim 1,
wherein the database is stored on a storage device.

5. The arrangement of claim 1,
wherein the delivery service unit is a shipping service provider.

6. The arrangement of claim 1,
wherein the identification item is at least one of the group consisting of a pendant, a label, a sticker, a tag, a garment, an engraving in the object, an imprint on the object, and a patch.

7. The arrangement of claim 1,
wherein the identification item is adapted to be connected to the object by at least one of the group consisting of mechanically connecting, adhering, gluing, sewing, wearing, printing, engraving, and ironing.

8. The arrangement of claim 1,
wherein the identification item is adapted to be destroyed or irreversibly modified when being removed from the object.

9. The arrangement of claim 1,
wherein the identification item is forgery-proof.

10. The arrangement of claim 1,
wherein the unique identification information is one of the group consisting of a sequence of letters, a sequence of numbers, and an alphanumerical code.

11. The arrangement of claim 1,
wherein the user data comprise at least one of the group consisting of a name of the user, a profession of the user, an income of the user, an age of the user, an address of the user, a personal preference of the user, a height of the user, a gender of the user, a title of the user, biometric data of the user, a weight of the user, a hair colour of the user, an eye colour of the user, and a family relationship of the user.

12. The arrangement of claim 1,
wherein the object is at least one of the group consisting of a key, a laptop, a phone, a portable entertainment device, a suitcase, a diving equipment, a traveller's device, a credit card, a bag, an animal, a pet, an object of art, a wooden object, gear, and a person.

13. The arrangement of claim 1,
wherein the database is protected against unauthorized access to the user data.

14. The arrangement of claim 1,
wherein the identification item includes a message promising a reward for the finder for the case that the finder notices that the finder has found the object connected to the identification item and provides the unique identification information.

15. The arrangement of claim 1,
comprising the delivery service unit.

16. The arrangement of claim 1,
wherein the identification item comprises a radio-frequency identification tag.

17. The arrangement of claim 1,
wherein the control unit is adapted to inform the user that the finder has found the object.

18. The arrangement of claim 1,
wherein the control unit is adapted to inform the user of the identity of the finder who has found the object.

19. The arrangement of claim 17,
wherein the control unit is adapted to inform the user by at least one of the group consisting of a text message, an SMS, an MMS, an email, a telephone call, a letter, and a facsimile.

20. A method of delivering a lost object to a user, the method comprising
connecting an identification item comprising unique identification information to the object;
providing, by the user, user data for registering the connection of the object to the identification item;
noticing, by a finder of the object connected to the identification item, that the finder has found the object connected to the identification item;
providing, by the finder, the unique identification information; and
delivering the object to the user based on the user data.

21. The method of claim 20,
wherein the object is delivered to the user with or without a fee.

22. The method of claim 20,
comprising providing the user data to a company for economic purposes or for marketing purposes.

23. The method of claim 20,
comprising informing the user that the finder has noticed that the finder has found the object connected to the identification item.

24. The method of claim 20,
wherein the object is delivered to the user by a delivery service after the delivery service has picked up the object from the finder.

25. The method of claim 20,
wherein the object is delivered to the user by the finder.

26. The method of claim 20,
wherein the finder is one of the group consisting of an airline, a ground handling agent, an airport authority and an airport staff member.

27. An arrangement, comprising
a control unit;
a database;
an identification item;
wherein the identification item comprises unique identification information and is adapted to be assigned to a user;
wherein the database is accessible to the user to provide user data for registering the user in connection with the identification item;
wherein the control unit is accessible to a finder of the identification item assigned to the user to inform the control unit, based on the unique identification information, that the finder has found the identification item assigned to the user;
wherein the control unit is adapted to provide the finder with the user data in case the finder has noticed that the finder has found the identification item.

28. The arrangement of claim 27,
wherein the control unit is adapted to provide the finder with user data only in case the user has agreed that the finder be provided with the user data in case the finder has noticed that the finder has found the identification item.

29. The arrangement of claim 27,
wherein the control unit is adapted to provide the finder with user data only in an emergency case, particularly in case of an accident of the user or in a medical emergency.

30. The arrangement of claim 27,
wherein the control unit is adapted to provide the finder with user data only in case the finder has been authorized before, during or after registration to be provided with the user data.

31. The arrangement of claim 28,
wherein the user data comprise medical information related to the user.

32. The arrangement of claim 28,
wherein the user data comprise at least one of the group consisting of an image showing the user, the blood type of the user, a disease the user may have, an allergy the user may have, an allergy to a medication the user may have, information regarding a medication to be administered to the user, information regarding possible organ donation of the user, and medical emergency related information of the user.

33. The arrangement of claim 27,
wherein the user data comprise at least one of the group consisting of the name of the user, the profession of the user, the user's income, the age of the user, an address of the user, a personal preference of the user, the height of the user, the gender of the user, the title of the user, biometric data of the user, the weight of the user, the hair colour of the user, the eye colour of the user, and the family relationship of the user.

34. The arrangement of claim 27,
wherein the control unit comprises a computer and/or a call center.

35. The arrangement of claim 27,
wherein the control unit is accessible to the finder via at least one of the group consisting of a computer network, a radio communication network and a telecommunication network.

36. The arrangement of claim 27,
wherein the database is stored on a storage device.

37. The arrangement of claim 27,
wherein the identification item is at least one of the group consisting of a pendant, a label, a sticker, a tag, a garment, an engraving in an object, an imprint on an object, and a patch.

38. The arrangement of claim 28,
wherein the identification item is adapted to be connected to an object by at least one of the group consisting of mechanically connecting, adhering, gluing, sewing, wearing, printing, engraving, and ironing.

39. The arrangement of claim 38,
wherein the identification item is adapted to be destroyed or irreversibly modified when being removed from the object.

40. The arrangement of claim 27,
wherein the identification item is forgery-proof.

41. The arrangement of claim 27,
wherein the unique identification information is one of the group consisting of a sequence of letters, a sequence of numbers, and an alphanumerical code.

42. The arrangement of claim 38,
wherein the object is at least one of the group consisting of a car, a door of an apartment or a house, a key, a laptop, a motorcycle helmet, a crash helmet, a phone, a portable entertainment device, a suitcase, diving equipment, a travelers device, a credit card, and a person.

43. The arrangement of claim 27,
wherein the database is protected against unauthorized access to the user data.

44. The arrangement of claim 27,
wherein the identification item comprises a radio-frequency identification tag.

45. The arrangement of claim 27,
wherein the control unit is adapted to inform the user that the finder has been provided with the user data.

46. The arrangement of claim 45,
wherein the control unit is adapted to inform the user via at least one of the group consisting of a text message, an SMS, an MMS, an email, a telephone call, a letter, and a facsimile.

47. The arrangement of claim 45,
wherein the control unit is adapted to inform the user via at least one of the group consisting of a text message, an SMS, an MMS, an email, a telephone call, a letter, and a facsimile. A method of providing a finder of an identification item with user data, the method comprising
assigning unique identification information of the identification item to a user;
providing, by the user, the user data for registering the user in connection with the identification item;
noticing, by a finder of the identification item, that the finder has found the identification item;
providing, by the finder, the unique identification information; and
providing the finder with the user data when the finder has noticed that the finder has found the identification item.

48. The method of claim 47,
wherein the finder is provided with the user data only after having performed a successful legitimation procedure.

49. The method of claim 47,
comprising informing the user that the finder will be provided with the user data.

50. The method of claim 47, comprising informing the user that the finder has been provided with the user data.

51. The method of claim 47, comprising providing the user data to a company for economic purposes or for marketing purposes.
